(19) United States
(12) Patent Application Publication
(10) Pub. No.: US 2008/0097860 A1
(43) Pub. Date: Apr. 24, 2008

(54) Systems and methods for advertising

(76) Inventors: Daryl David Coutts, Edmonton (CA); Stephen Harrison Johnston, Calgary (CA)

Correspondence Address: Daryl D. Coutts, Suite 207, 11103 84 Ave, Edmonton, AB, T6G 2X4, CA

(21) Appl. No.: 11/987,140

(22) Filed: Nov. 28, 2007

Related U.S. Application Data
(60) Provisional application No. 60/861,414, filed on Nov. 29, 2006.
(60) Provisional application No. 60/907,787, filed on Apr. 17, 2007.
(60) Provisional application No. 60/924,347, filed on May 10, 2007.
(60) Provisional application No. 60/924,575, filed on May 21, 2007.
(60) Provisional application No. 60/929,090, filed on Jun. 12, 2007.
(60) Provisional application No. 60/929,463, filed on Jun. 28, 2007.
(60) Provisional application No. 60/929,618, filed on Jul. 5, 2007.

(51) Int. Cl. G06Q 30/00

(52) U.S. Cl. 705/14

(57) ABSTRACT

Systems and methods for advertising on a computing device are described.

### CROSS REFERENCE TO RELATED APPLICATIONS

This application claims the benefit of priority under 35 USC 119(e) to U.S. Provisional Application No. 60/861,414, filed Nov. 29, 2006, entitled “SYSTEM FOR DELIVERING VIDEO ADS TO HANDHELD DEVICES”; U.S. Provisional Application No. 60/907,787, filed Apr. 17, 2007, entitled “METHODS AND SYSTEMS FOR PROMPTING USERS OF COMPUTING DEVICES”; U.S. Provisional Application No. 60/924,347, filed May 10, 2007, entitled “METHODS AND SYSTEMS FOR PROMPTING USERS OF COMPUTING DEVICES”; U.S. Provisional Application No. 60/924,575, filed May 21, 2007, entitled “METHODS AND SYSTEMS FOR PROMPTING USERS OF COMPUTING DEVICES”; U.S. Provisional Application No. 60/929,090, filed Jun. 12, 2007, entitled “SYSTEMS AND METHODS FOR ADVERTISING”; U.S. Provisional Application No. 60/929,463, filed Jun. 28, 2007, entitled “SYSTEMS AND METHODS FOR INFORMATION PRESENTATION”; and U.S. Provisional Application No. 60/929,618, filed Jul. 5, 2007, entitled “ADVERTISING INTERMEDIATION SERVER”, all of which are incorporated herein by reference in their entirety.

### TECHNICAL FIELD

The invention relates to rewarding computing device users for viewing advertisements on their computing devices.

### BACKGROUND OF THE INVENTION

The internet is driven by advertising. The primary focus of the largest and most successful companies of today is advertising. Advertising is a vital aspect of the internet. Content providers get paid for their work by selling advertising space associated with the presentation of their content. Internet users access content, often without charge, because the content is provided with associated advertising. Advertising intermediaries extract the lion's share of the rents associated with such a system. The internet allows two-way communication between the advertiser and the consumer. This two-way communication increases the value of advertising to internet users substantially. Further, the ability of an advertiser to know precisely who they are presenting to further increases the richness of the internet delivery channel.

The problem with the current advertising system on the internet is that the value is concentrated in the hands of the advertising system providers. Substantial value is attributed to the content consumer, but the content consumer is underpaid for their valuable screen space.

Content consumers are undercompensated in the current advertising system because advertisements are generally displayed in response to content consumers actions. The content consumer navigates to a certain webpage or enters search terms into a search page and then advertisements are displayed.

What is needed is a system that facilitates the more direct attribution of value to internet users. What is needed is a way that internet users can rent their valuable screen space to advertisers while preserving value for advertisers.

### BRIEF SUMMARY OF THE INVENTION

In one embodiment, client software is provided to a user's computing device. The client software is configured to discontinuously show advertisements at scheduled times on a display associated with the computing device. The time between the showing of advertisements is generally greater than the time each advertisement is shown. The user is rewarded for participating in the system and the reward is a function of the number of advertisements shown.

In another embodiment, on the computing device the display of an ad is scheduled and the ad is displayed for a period of time. Monitoring is done for user input and information regarding user input may be sent to a server. Also, scheduling information for the ad may be obtained from the server.

The described systems and methods allow a user to be rewarded for allowing advertisements to be shown on the display associated with their computing device, while providing good value to advertisers and minimizing user abuse of a “pay for advertising” system.

Other objects, features and advantages of the present invention will become apparent upon perusal of the following description in conjunction with the appended drawings.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary system for scheduling and displaying advertisements on a computing device.

FIG. 2 illustrates an exemplary advertisement shown on a display of a computing device.

FIG. 3 illustrates an exemplary method that can be executed on client computing device.

### DESCRIPTION OF EMBODIMENTS

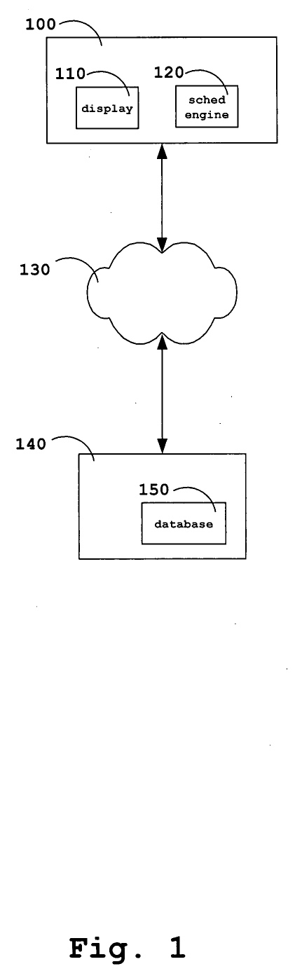

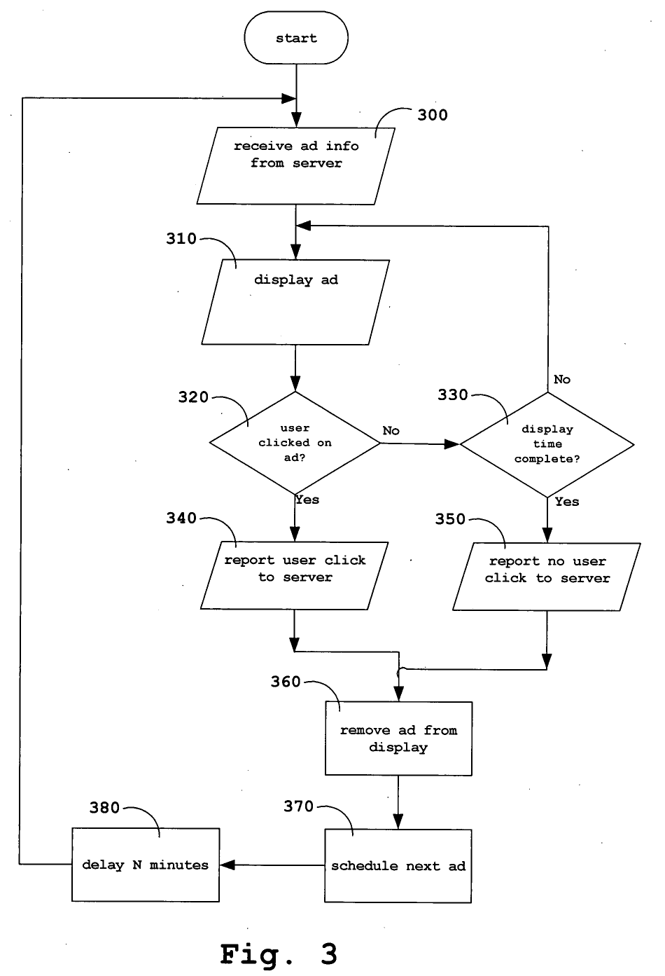

FIG. 1 illustrates a system where a computing device 100 communicates with a second computing device 140 via a network 130. The computing device 100 can be any suitable computing device examples of which include: cellphone, handheld, PDA, desktop computer, notebook computer and server. The computing device 100 has an associated display 110 and a scheduling engine 120 (discussed later in relation to FIG. 3). The second computing device 140 can be a server implemented on desktop computer, notebook computer or any other suitable computing device. The second computing device 140 has an associated database 150 (discussed later in relation to FIG. 3). The network 130 can be any suitable network such as the internet, wireless network and cellphone network.

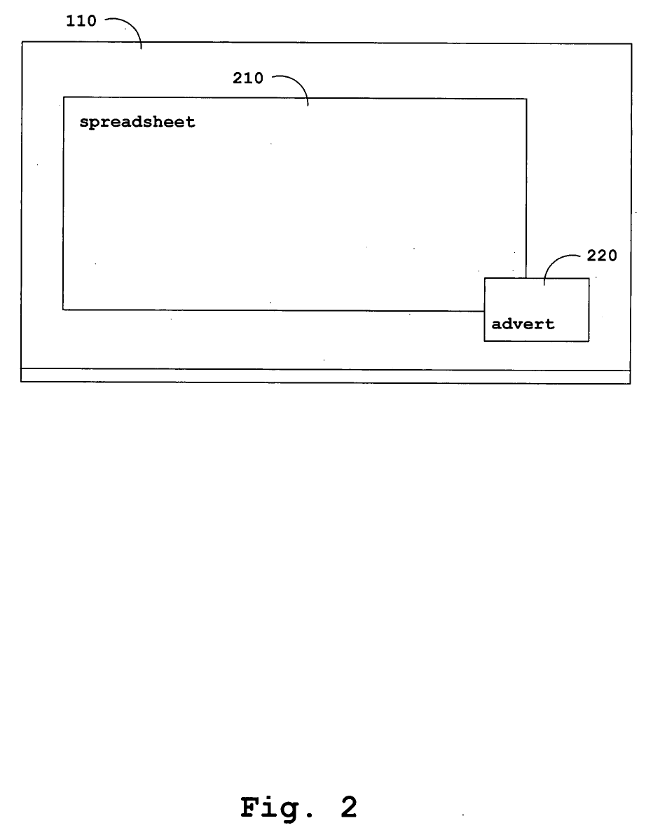

FIG. 2 illustrates how an advertisement 220 may look when it is shown on a display 110. 210 represents a window of an application running on the computing device 100.

FIG. 3 illustrates a method that can be implemented on the computing device 100. In block 300, advertisement information can be received from the second computing device 130. This advertisement information can be a link to an ad and it can include information corresponding to the value of the ad to user. As indicated earlier, the second computing device 140 can be a server. In block 310, an advertisement 220 is shown on the display 110. While the advertisement 220 is shown, user input is monitored on the computing device 100 to determine if the user has directed input at the advertisement 220. This can be done synchronously as shown in FIG. 3 or it can be done on an event driven basis. At block 330, a timer is monitored, if the advertisement 220 has been displayed for sufficient time, the method continues at block 350. Blocks 340 and 350 report user activity to the second computing device 130. At block 360, the advertisement 220 is removed from the display 110, this can be making the advertisement 220 substantially not visible on the display 110. In block 370, the next advertisement 220 display is scheduled by the scheduling engine 120. Scheduling can be accomplished by setting a timer for a predetermined number of minutes as in block 380 or scheduling can be done using the scheduling capability of the operating system on the computing device 100 or scheduling the next advertisement 220 display can be implemented other ways.

As described earlier, the second computing device 140 is typically a server with an associated database 150. The database 150 can store advertising information that is sent to the computing device 100. The database 150 can also store information corresponding to user input directed at the displayed advertisement 220. The database 150 can store the number of advertisements 220 displayed on the computing device 100. A reward can be provided to the user of the computing device 100 based on the number of advertisements 220 shown.

In an embodiment, the advertisement 220 can be displayed every twenty minutes for thirty seconds. By choosing an interval between the showing of advertisements 220 that is quite long compared to the actual time the advertisement 220 is shown, the effectiveness of the advertisement is improved because the user of the computing device 100 has not tuned out the advertisement. Other intervals and display times are of course possible within the scope of the embodiment. The scheduled times for the display of the advertisements 220 can be based at least partly on scheduling information received from the second computing device 140 (the server). By scheduling the showing of advertisements 220, a user of the computing device 100 is unable to be nefariously rewarded for viewing a large number of advertisements 220 on their computing device 100.

Many alternative embodiments to the above described methods and systems are possible. While various embodiments have been described above, it should be understood that it has been presented by way of example only, and not limitation.

We claim:

1. A method implemented on a client computing device, the method comprising:
scheduling the display of a first advertisement;
displaying the first advertisement on a display associated with the client computing device; and
after a first period of time, removing the advertisement from the display.

2. The method of claim 1 further comprising receiving scheduling information from a first server.

3. The method of claim 1 further comprising detecting that a user associated with the client computing device has directed input at the displayed first advertisement and transmitting information corresponding to the user input to a second server.

4. The method of claim 3 where the first server is the same server as the second server.

5. A method for operating an advertising network comprising:
providing client software for a user's computing device, the client software configured to discontinuously show advertisements at scheduled times on a display associated with the computing device, wherein the time between showing of the advertisements is generally greater than the time each advertisement is shown; and
providing a reward to the user, where the reward is a function of the number of advertisements shown.

6. An advertising system where a user opts in to receive advertisements displayed on their client computing device in exchange for a reward and wherein the reward is proportionate to the number of advertisements that are displayed on the client computing device and wherein scheduling information associated with the advertisements is provided to the client computing device by a server.
